(19) United States
(12) Patent Application Publication
(10) Pub. No.: US 2008/0120508 A1
(43) Pub. Date: May 22, 2008

(54) Method and Apparatus for Facilitating the Resetting of a Presently Used Password

(75) Inventors: John A. Marconi, Hoffman Estates, IL (US); Christopher Swider, Evanston, IL (US); Devarajan Puthupparambil, Mt. Prospect, IL (US)

Correspondence Address: UTSTARCOM, INC. / FETF, 120 S. LASALLE STREET, SUITE 1600, CHICAGO, IL, 60603-3406, US

(73) Assignee: UTSTARCOM, INC., Alameda, CA (US)

(21) Appl. No.: 11/561,642

(22) Filed: Nov. 20, 2006

(51) Int. Cl. H04L 9/32

(52) U.S. Cl. 713/184

(57) ABSTRACT

A platform (200) having a default password and a presently used password stored therein receives (101) data from a portable physical data carrier and extracts (102) information comprising a unique code and a count as correspond to the platform. When a comparison (104) of the code and the count with corresponding information in the platform is favorable, the platform then resets (106) the presently used password to the default password. To facilitate the provision of such a portable physical data carrier, upon detecting (301) a need to reset this presently assigned password at a remotely located platform to a default password, the aforesaid unique code and count are recovered (302, 303) and placed (305) on the portable physical data carrier along with an instruction regarding resetting of the presently used password. That portable physical data carrier can then be physically forwarded (306) to that platform to facilitate the foregoing steps.

### TECHNICAL FIELD

This invention relates generally to the use of passwords and more particularly to the resetting of a presently used password.

### BACKGROUND

Systems of various kinds are known that use one or more passwords to control, to a greater or lesser degree, a kind of interaction by which a given user can engage the system. In some cases, such a password may serve to determine whether the would-be user can interact in any substantive way with the system. In other cases, the extent of a given user's interaction (such as whether the user is permitted to read or otherwise access certain files, to write to or otherwise edit certain files, to download programs or to make other administrative changes, and so forth) are at least partially dependent upon their proffered password.

In many such cases, such a system will initially ship with a default password (such as the somewhat ubiquitous and overused “password”). The recipient of such a system is then instructed and urged to replace that default password with a password of their own choosing in order to obtain the benefits of the protection and security that attends the usage of an appropriate relatively secret password. Unfortunately, from time to time, it is possible for a user of such a system to lose or forget such a password. In a not uncommon scenario, the loss of such a password is highly debilitating and can serve to prohibit the user from carrying out routine but necessary maintenance, upgrades, and so forth.

To attempt to meet such a need, some solutions in this regard provide a mechanism whereby a given presently assigned/used password can be selectively reset to the default password. Once reset in this manner, the user can then use the default password to effectively begin anew and assign a new private password for subsequent on-going use. Such a capability, however, presents a considerable risk to security. Indeed, such a capability would appear to offer a willful unauthorized individual a useful and practical way to breach the security offered by a password protected platform. As a result, though mindful of the great inconvenience and even performance risk that one assumes by relying only upon an ability to always reliably draw upon knowledge of a presently assigned password, many systems users can be expected to nevertheless continue to endure such a risk in order to avoid the risk of using an easily avoided password resetting protocol.

### BRIEF DESCRIPTION OF THE DRAWINGS

The above needs are at least partially met through provision of the method and apparatus for facilitating the resetting of a presently used password described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a flow diagram as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a given platform having a default password and a presently used password stored therein is configured and arranged to receive data from a portable physical data carrier and to extract information from that data comprising, at least in part, a unique code as corresponds to the platform and a count as also corresponds to that platform. When a comparison of the unique code and the count with corresponding information in the platform is favorable, the platform then automatically resets the presently used password to the default password. To facilitate the provision of such a portable physical data carrier, upon detecting a need to reset this presently assigned password at a remotely located platform to a default password, the aforesaid unique code and count can be recovered and placed on the portable physical data carrier along with an instruction to the remotely located platform regarding resetting of the presently used password. That portable physical data carrier can then be physically forwarded to the remotely located platform to facilitate the foregoing steps.

These teachings are readily applicable to accommodate platforms having a plurality of assignable passwords and/or a plurality of default passwords. By one approach these password restoration steps can comprise a one-time-only capability. If desired, however, a plurality of such restorations can be accommodated. By one approach, if desired, the noted count can serve to facilitate limiting the number of restoration events for a given platform to no more than a predetermined upper limit and/or to limit the number of times that such a data carrier can serve to effect such resetting of a password.

Those skilled in the art will recognize and appreciate that such an approach serves to readily accommodate and facilitate the resetting of a presently used/assigned password in a given platform to a default password while simultaneously offering great security. The unique code aids with preventing inadvertent or intentional misuse of the portable physical data carrier. Similarly, the count can serve to prevent using the portable physical data carrier for more than one such password resetting exercise. The use of physical media to effect such resetting of the password provides further security in this regard. It will be understand that these teachings are readily applied and leveraged in a variety of application settings and are further readily scaled to meet the needs, requirements, and/or opportunities as pertain to a given application setting.

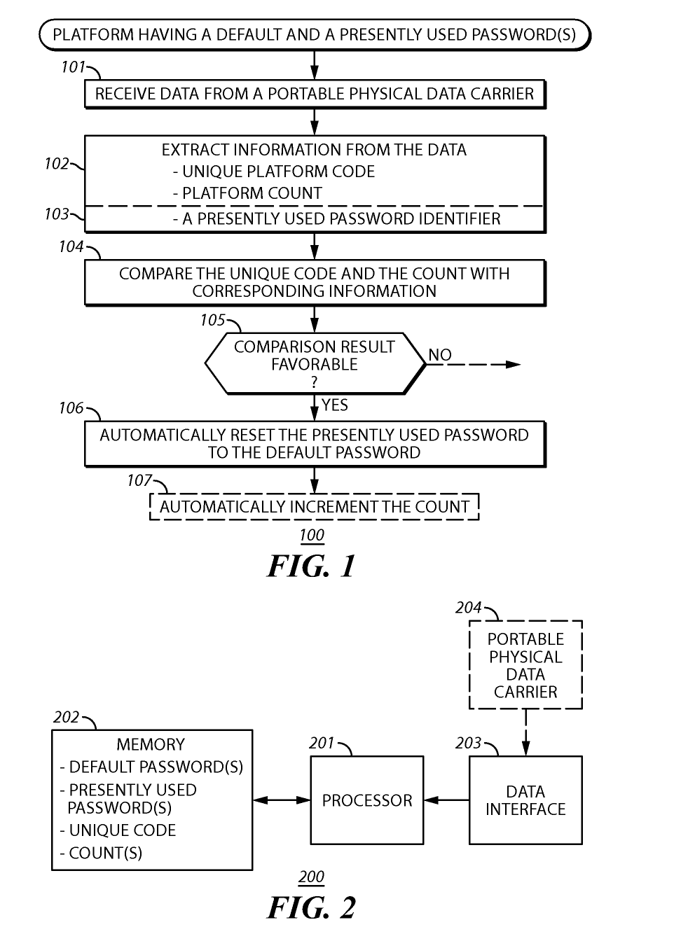

These and other benefits may become clearer upon making a thorough review and study of the following detailed description. Referring now to the drawings, and in particular to FIG. 1, an illustrative process 100 that can be carried out by a platform having both a default password (or passwords) and a presently used password (or passwords) will be presented. As noted above, such passwords can serve a multitude of purposes. As but one example in this regard, the presently used password can comprise an administrator's password as is well-understood in the art.

Pursuant to this process 100 this platform receives 101 data from a portable physical data carrier. Various portable physical data carriers are known in the art and would suffice for these purposes. By one approach, this portable physical data carrier can comprise a portable digital memory such as, but not limited to, a so-called smart card or the like. By one approach, if desired, the portable digital memory can have a unique form factor that the platform must uniquely accommodate in order to facilitate extracting data from the portable physical data carrier. When the portable physical data carrier comprises a portable digital memory, this step of receiving 101 data can comprise reading the data from the portable digital memory. Various means and techniques for accomplishing such a step are well known in the art. As these teachings are not particularly sensitive with respect to the selection of any particular approach in this regard, for the sake of brevity further elaboration on this point will not be provided here.

This process 100 then provides for extracting 102, from the aforementioned data, information comprising a unique code as corresponds to the platform and a count as also corresponds to the platform. The unique code can comprise a publicly ascertainable code such as, but not limited to, a serial number as is substantially uniquely assigned to the platform. Other numbers could serve as well in this regard provided the number tends towards uniqueness as regards the platform and other related platforms (such as similar platforms as are manufactured by a same manufacturer). The count can comprise a number of times that a presently used password at the platform has been reset to a default condition. The use of such a count will be discussed below in more detail.

By one approach, if desired, some or all of the aforementioned data can be encrypted. This can comprise, for example, encrypting the data using public key encryption techniques where, for example, the platform has a corresponding private key that can be employed to decrypt the public key encrypted data. In such a case, if desired, the private key can be substantially unique to the platform. Again, such encryption and decryption techniques comprise a well understood area of endeavor and require no further explanation here.

As noted earlier, the platform in question may have more than one presently used password and/or default password. In such a case, it may be useful for the aforementioned data to also comprise an identifier that identifies the particular presently used password to be reset and/or the particular default password to be used when resetting the presently used password. In such a case, this step of extracting the information can further optionally comprise extracting 103 this identifier as corresponds to a particular one of the passwords at issue.

This process 100 then provides for comparing 104 the extracted unique code and count with corresponding information available to the platform to thereby provide a corresponding comparison result. This can simply comprise, for example, comparing the extracted unique code with the actual unique code as corresponds to this particular platform. When a match occurs, it becomes more reasonable to conclude that the contents of the portable physical data carrier are intended for this particular platform.

The comparison of count values can also serve to prohibit an unauthorized or inappropriate use of the contents of the portable physical data carrier. For example, by one approach, only a single lifetime password reset event may be permitted for a given platform. In such a case, a count comparison that evidences a contrary result can serve to guide platform behavior other than use of the information contents to reset a password. As another example, this count comparison can be used to prevent a given portable physical data carrier from being used more than once (or some other number of times to which the carrier may be set). To illustrate, when the existing count at the platform is “2” and the count value in the portable physical data carrier is also “2,” a corresponding password reset can be permitted. When the count value at the platform is “3,” however, a conclusion can be drawn that the portable physical data carrier contains old information and should not serve as the basis of a current password resetting event.

When this comparison result 105 is unfavorable, the process 100 can proceed as desired. By one approach, the process 100 can simply conclude at this point. If desired, a message can be provided to the user to indicate a refusal to proceed further. By yet another approach, a log entry can be created to provide an audit trail regarding such events. By yet another approach the platform can source a message, such as an email, to an administrator or other interested party regarding this circumstance.

When the comparison result 105 is favorable, however, this process 100 then automatically resets 106 the presently used password to the corresponding default password. When the platform uses a plurality of passwords, the aforementioned password identifier can serve to identify the particular presently assigned password to reset and/or the particular default password to use when resetting the presently assigned password.

If desired, this process 100 will optionally further provide for automatically incrementing 107 the aforementioned count to thereby update the count of the number of times that a presently used password at the platform has been reset to a default password. By one approach, this can comprise updating an aggregate count that corresponds to all resetting events for all passwords at the platform. By another approach, a separate count can be maintained for each such password.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform 200 will now be provided.

In this example, the platform 200 comprises a processor 201, a memory 202, and a data interface 203. The processor 201 can comprise, for example, a programmable mechanism that is programmed to perform or to otherwise facilitate the above-described steps. The memory 202 operably couples to the processor 201 and has stored therein the aforementioned default password(s), presently used password(s), unique code, and count(s) as correspond to this platform 200. The data interface 203 also operably couples to the processor 201 and is configured and arranged to physically and communicatively interface with a portable physical data carrier 204 as described above to receive the data contained therein.

Those skilled in the art will recognize and understand that such a platform 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

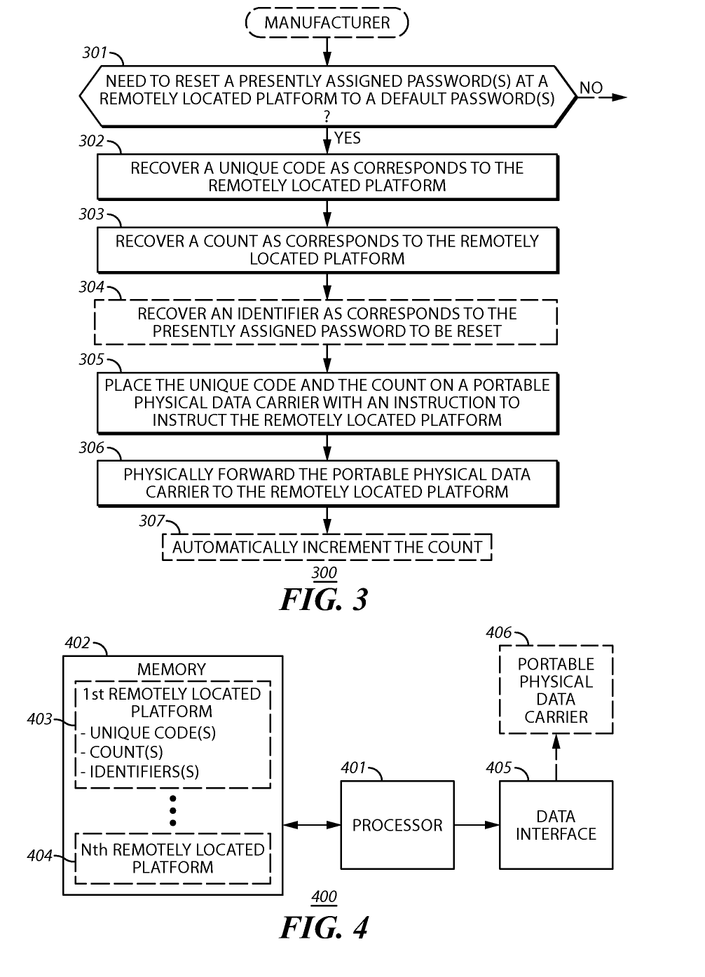

As noted, the above-described process relies, in part, upon the availability of a properly configured portable physical data carrier. Referring now to FIG. 3, a process 300 by which an interested authorized party, such as the manufacturer of the aforementioned platform, can provide such a portable physical data carrier will be described.

Pursuant to this process 300, upon detecting 301 a need to reset a presently assigned password at a remotely located platform to a default password, a unique code as corresponds to that platform is recovered 302. As noted above, this unique code can comprise, if desired, a publicly available number such as, but not limited to, a serial number as corresponds to the platform in question. This process 300 also provides for recovering the aforementioned count as corresponds to the remotely located platform. And, when the remotely located platform has a plurality of passwords, this process 300 will also optionally provide for recovering 304 an identifier as corresponds to the presently assigned password that is to be reset (and/or the default password to be employed when resetting the presently assigned password).

This process 300 then provides for placing 305 that recovered information on a portable physical data carrier of choice along with an instruction to trigger, guide, or otherwise influence the remotely located platform with respect to facilitating the desired password resetting event. By one approach, this instruction can comprise a corresponding code or executable software instructions. By another approach, if desired, provision of the unique code and count information can itself serve as this instruction when the remotely located platform is programmed and configured to make such an interpretation. As noted above, this information can be encrypted when placed on the portable physical data carrier. In that case, an encryption key, such as a public encryption key, can serve to facilitate such encryption.

This process 300 then provides for physically forwarding 306 the portable physical data carrier to the remotely located platform. This can comprise the use of public or private delivery services as are known in the art. By one approach the portable physical data carrier can be addressed to a specific previously approved and vetted recipient (such as, for example, a particular individual who serves as the chief information technologies administrator for the recipient).

If desired, this process 300 will also optionally provide for automatically incrementing 307 the aforementioned count in order to have local information that correlates to what should be stored at the remotely located platform following the password resetting event.

Those skilled in the art will appreciate that the above-described processes are readily enabled using any of a wide variety of available and/or readily configured apparatuses, including partially or wholly programmable apparatuses as are known in the art or dedicated purpose platforms as may be desired for some applications. Referring now to FIG. 4, an illustrative approach to such an apparatus 400 will now be provided.

In this example, the apparatus 400 comprises a processor 401 that operably couples to a memory 402 and a data interface 405. The processor 401 itself can comprise a programmable component that is programmed and configured to carry out the aforementioned steps. The memory 402 can serve to store the aforementioned information regarding at least a first remotely located platform 403. In many cases it may be useful to store such information for a plurality of such remotely located platforms (represented here by an Nth remotely located platform 404 where “N” will be understood to comprise an integer greater than one).

The data interface 405 can be configured and arranged to physically and communicatively couple to the aforementioned portable physical data carrier 406. So configured, the process 401 can use the information contained in the memory 402 to populate the portable physical data carrier 406. So populated, the latter can then be physically forwarded to the remotely located platform to effect the authorized password resetting event.

Those skilled in the art will recognize and appreciate that these teachings are relatively simple to implement in a relatively economic manner. These teachings are highly flexible and will accommodate a wide range of application settings. These teachings are also highly scalable. So configured, a high degree of security can be imbue the password resetting process, thereby providing needed assurances in this regard while also facilitating the accurate and appropriate resetting of passwords as appropriate.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, if desired, when the platform has a plurality of passwords, this process can be employed to automatically reset each and every one of the plurality of passwords to a same default password in a single step. As another example in this regard, the unique code and count information can be interleaved with one another and that resultant aggregated information parsed over two or more portable physical data carriers. So configured, the receiving platform could then be configured to use all such carriers simultaneously or to accept their data as presented in succession.

We claim:

1. A method comprising:
at a platform having a default password and a presently used password stored therein:
receiving data from a portable physical data carrier;
extracting from the data information comprising:
a unique code as corresponds to the platform;
a count as corresponds to the platform;
comparing the unique code and the count with corresponding information to provide a comparison result;
when the comparison result is favorable, automatically resetting the presently used password to the default password.

2. The method of claim 1 wherein the presently used password comprises an administrator's password.

3. The method of claim 1 wherein the portable physical data carrier comprises a portable digital memory.

4. The method of claim 3 wherein the portable digital memory comprises a smart card.

5. The method of claim 3 wherein receiving data from a portable physical data carrier comprises reading the data from the portable digital memory.

6. The method of claim 1 wherein extracting from the data the information comprises decrypting the data.

7. The method of claim 6 wherein decrypting the data comprises decrypting public key encrypted data using a private key.

8. The method of claim 7 wherein the private key is substantially unique to the platform.

9. The method of claim 1 wherein the unique code comprises a serial number as is substantially uniquely assigned to the platform.

10. The method of claim 1 wherein the unique code comprises a publicly ascertainable code.

11. The method of claim 1 wherein the count as corresponds to the platform comprises a count regarding a number of times a presently used password at the platform has been reset to the default password.

12. The method of claim 11 further comprising:
upon automatically resetting the presently used password to the default password, automatically incrementing the count.

13. The method of claim 1 wherein:
the platform has a plurality of presently used passwords stored therein;
extracting from the data further comprises extracting from the data information comprising an identifier as corresponds to at least a particular one of the plurality of presently used passwords;
automatically resetting the presently used password to the default password comprises automatically resetting the particular one of the plurality of presently used passwords to a default password as corresponds to the particular one of the plurality of presently used passwords.

14. An apparatus comprising:
a memory having stored therein a default password, a presently used password, a count as corresponds to the apparatus, and a unique code as corresponds to the apparatus;
a data interface configured and arranged to receive data from a portable physical data carrier;
a processor operably coupled to the memory and the data interface and being configured and arranged to:
extract information from the data;
compare the unique code as corresponds to the apparatus and the count as corresponds to the apparatus with the information to provide a comparison result;
when the comparison result is favorable, automatically resetting use of the presently used password to the default password.

15. The apparatus of claim 14 wherein the presently used password comprises an administrator's password.

16. The apparatus of claim 14 wherein the portable physical data carrier comprises a portable digital memory.

17. The apparatus of claim 16 wherein the portable digital memory comprises a smart card.

18. The apparatus of claim 14 wherein the processor is further configured and arranged to extract the information from the data by decrypting the data.

19. The apparatus of claim 18 wherein decrypting the data comprises decrypting public key encrypted data using a private key.

20. The apparatus of claim 19 wherein the private key is substantially unique to the platform.

21. The apparatus of claim 14 wherein the unique code comprises a serial number as is substantially uniquely assigned to the apparatus.

22. The apparatus of claim 14 wherein the unique code comprises a publicly ascertainable code.

23. The apparatus of claim 14 wherein the count as corresponds to the platform comprises a count regarding a number of times a presently used password at the platform has been reset to the default password.

24. The apparatus of claim 23 wherein the processor is further configured and arranged to automatically increment the count upon resetting the presently used password to the default password.

25. The apparatus of claim 14 wherein
the memory has stored therein a plurality of presently used passwords;
the processor is further configured and arranged to extract information from the data comprising an identifier as corresponds to at least a particular one of the plurality of presently used passwords;
and wherein automatically resetting use of the presently used password to the default password comprises automatically resetting use of the particular one of the plurality of presently used passwords to a default password as corresponds to the particular one of the plurality of presently used passwords.

26. A method comprising:
upon detecting a need to reset a presently assigned password at a remotely located platform to a default password:
recovering a unique code as corresponds to the remotely located platform;
recovering a count as corresponds to the remotely located platform;
placing the unique code and the count on a portable physical data carrier along with an instruction to instruct the remotely located platform;
physically forwarding the portable physical data carrier to the remotely located platform.

27. The method of claim 26 wherein the unique code comprises a serial number as is assigned to the remotely located platform.

28. The method of claim 26 wherein the presently assigned password comprises a particular one of a plurality of presently assigned passwords as are used at the remotely located platform.

29. The method of claim 28 further comprising:
placing an identifier as corresponds to a particular one of a plurality of presently assigned passwords as are used at the remotely located platform on the portable physical data carrier.

30. The method of claim 26 wherein the portable physical data carrier comprises a portable digital memory.

31. The method of claim 30 wherein the portable digital memory comprises a smart card.

32. The method of claim 26 wherein the count as corresponds to the remotely located platform comprises a count regarding a number of times a presently used password at the remotely located platform has been reset to the default password.

33. The method of claim 32 further comprising:
automatically incrementing the count.

34. The method of claim 26 wherein placing the unique code and the count on a portable physical data carrier comprises encrypting the unique code and the count.

35. The method of claim 34 wherein encrypting the unique code and the count comprises encrypting the unique code and the count using public key encryption.

36. An apparatus comprising:
a memory having stored therein a unique code as corresponds to a remotely located platform and a count as corresponds to the remotely located platform;
a data interface configured and arranged to write data to a portable physical data carrier;
a processor operably coupled to the memory and the data interface and being configured and arranged to:
retrieve the unique code;
retrieve the count;
place the unique code and the count on the portable physical data carrier along with an instruction to instruct the remotely located platform to reset a presently used password to default password;
such that the portable physical data carrier can then be physically delivered to the remotely located platform to facilitate resetting a presently used password to the default password.

37. The apparatus of claim 36 wherein the unique code comprises a serial number as is assigned to the remotely located platform.

38. The apparatus of claim 36 wherein the presently used password comprises a particular one of a plurality of presently used passwords as are used at the remotely located platform.

39. The apparatus of claim 38 wherein the processor is further configured and arranged to place an identifier as corresponds to the particular one of the plurality of presently used passwords as are used at the remotely located platform on the portable physical data carrier.

40. The apparatus of claim 36 wherein the portable physical data carrier comprises a portable digital memory.

41. The apparatus of claim 40 wherein the portable digital memory comprises a smart card.

42. The apparatus of claim 36 wherein the count as corresponds to the remotely located platform comprises a count regarding a number of times a presently used password at the remotely located platform has been reset to the default password.

43. The apparatus of claim 42 wherein the processor is further configured and arranged to automatically increment the count.

44. The apparatus of claim 36 wherein the processor is further configured and arranged to place the unique code and the count on a portable physical data carrier by encrypting the unique code and the count.

45. The apparatus of claim 44 wherein encrypting the unique code and the count comprises encrypting the unique code and the count using public key encryption.
